(19) United States
(12) Patent Application Publication
(10) Pub. No.: US 2008/0284973 A1
(43) Pub. Date: Nov. 20, 2008

(54) LAYER ALIGNMENT OF SMECTIC LIQUID CRYSTALS

(76) Inventors: Bentley Wall, Kent, OH (US); Dmylro Reznikov, Cuyahoga Falls, OH (US); Philip Bos, Hudson, OH (US); Michael J. O'Callaghan, Louisville, CO (US); Mark A. Handschy, Boulder, CO (US)

Correspondence Address: MARSH, FISCHMANN & BREYFOGLE LLP, 8055 East Tufts Avenue, Suite 450, Denver, CO, 80237, US

(21) Appl. No.: 12/122,452

(22) Filed: May 16, 2008

Related U.S. Application Data
(60) Provisional application No. 60/938,617, filed on May 17, 2007.

(51) Int. Cl. G02F 1/13

(52) U.S. Cl. 349/187

(57) ABSTRACT

A method of fabricating a liquid crystal display device by introducing a ferroelectric liquid crystal (FLC) between two substrates, contacting the FLC to a molecularly smooth edge, and aligning the FLC by introducing a temperature gradient normal to the edge. In one embodiment, the FLC is aligned by cooling it from an isotropic phase to a smectic phase at a rate that is relatively slow. For example, the cooling rate may be less than about 3 degrees Celsius per hour. In one embodiment, smectic layers are formed that are parallel to the edge. In one embodiment, the molecularly smooth edge is an air bubble.

### CROSS-REFERENCE TO RELATED APPLICATION

This application claims priority under 35 U.S.C. 119 to U.S. Provisional Application No. 60/938,617, entitled: “LAYER ALIGNMENT OF SMECTIC LIQUID CRYSTALS,” filed on May 17, 2007, the contents of which are incorporated herein as if set forth in full.

### BACKGROUND

The alignment of the layered structure of smectic liquid crystals has received attention in the last decades, particularly due to numerous display applications. Ferroelectric liquid crystal displays utilizing chiral Smectic C (SmC) have many attractive features such as fast response time and bistability. Most of the materials that are used in ferroelectric displays possess I-N-A-C phase sequence (Isotropic-Nematic-Smectic A-Smectic C). Such materials are usually aligned using conventional methods, such as rubbing of a polymer surface layer, oblique deposition of SiOₓ and photo-alignment. In this case, the liquid crystal director is aligned in the nematic phase, which results in uniform alignment of the smectic layers in the Smectic A phase upon cooling.

However, there is a class of ferroelectric materials with some useful characteristics, such as a large cone angle and reduced layer shrinkage, which have I-A-C phase sequence (Isotropic-Smectic A-Smectic C). For such materials, conventional methods do not work due to the absence of nematic phase. Several methods have been proposed for aligning I-A-C liquid crystals. They include using rubbed nylon as the alignment layer, gentle shearing of the cell in the Smectic A (SmA) phase, applying magnetic field during cooling from isotropic to SmA phase and technique of spatial gradient cooling.

In the usual nematic (N) liquid crystalline phase, the average molecular alignment is along a direction that defines the director, and there is not spatial ordering of the molecules. In the cooler temperature SmA, the molecules become arranged in layers that are perpendicular to the director. A yet cooler temperature phase is the SmC that is used for many display applications. In this phase the layer orientation from the SmA is basically preserved, while the director tilts from the layer normal and becomes free to rotate about the layer normal.

For many display applications, including those using the SmC phase, it is important to create a well-aligned layer structure in the SmA phase. This is to be distinguished from the director alignment that is desired for nematic devices.

There have been many methods proposed to achieve alignment of the SmA layers. The most successful of these are useful in materials that have the Isotropic-Nematic-Smectic A (I-N-A-) phase sequence. In this case, a surface orientation layer is applied to the surfaces of the liquid crystal (LC) cell, that aligns the director in the nematic phase, and then subsequent cooling to the SmA phase yields the desired layer structure. But this method has at least two limitations. One is that it is only applicable to LC materials that have the I-N-A-phase sequence, and the other is that the surface alignment required to align the director in the nematic phase may have detrimental effects on the electro-optic performance of the device in the SmC phase (for example). It turns out that both of these limitations are severe ones, as many useful LC materials have been designed that do not have a nematic phase, and for some applications surface alignment required by this method is problematic. For these reasons, other methods of alignment have been proposed for materials that do not have a nematic phase, but have an I-A-phase sequence. However, none of them has been able to be used to solve both the above problems in a clearly acceptable manner.

One previously known method of aligning SmA layers may be used to form the LC cell shown in FIG. 1. This method includes the alignment of SmA layers 2A-F from the isotropic phase based on nucleation of the layers 2A-F from an edge 4, where alignment generated from the edge 4 causes the smectic layers 2A-F to be perpendicular to it.

It is against this background that the present invention has been developed.

### SUMMARY

A method of fabricating a liquid crystal display device includes providing a first substrate; providing a second substrate; spacing the first and second substrates apart by a gap; providing a molecularly smooth edge within the gap; providing a ferroelectric liquid crystal between the first and second substrates; wherein a portion of the ferroelectric liquid crystal is in contact with the edge; and aligning the ferroelectric liquid crystal by introducing a temperature gradient normal to the edge. The ferroelectric liquid crystal phase-changes into a smectic phase during the aligning step.

The edge may be formed with an air bubble. The aligning may include cooling the ferroelectric liquid crystal at rate of below 3 degrees Celsius per hour. The temperature gradient may be between approximately 10-20 K/mm. A plurality of smectic layers that are parallel to the edge may be formed during the aligning step.

### BRIEF DESCRIPTION OF THE DRAWINGS

FIG. 1 illustrates a prior art liquid crystal cell that includes a formation of smectic layers that are formed perpendicular to an edge.

FIG. 2 illustrates one embodiment of a liquid crystal cell.

FIG. 3 illustrates a top and cross-sectional view of a liquid crystal device.

FIG. 4 illustrates a graph of the temperature gradient at one point in time for the liquid crystal cell of FIG. 3.

FIGS. 5A-B illustrate etched channels in ITO covered glass substrates using a patterned photoresist layer and hydrofluoric acid.

FIG. 6 illustrates a system for creating a temperature gradient for use in fabricating a liquid crystal cell.

FIGS. 7A-B illustrate defects in the alignment process that were observed at higher cooling rates.

FIG. 8 is a top view of a liquid crystal cell.

FIG. 9 is a top view of a liquid crystal cell.

### DETAILED DESCRIPTION

While the invention is susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the scope and spirit of the invention as defined by the claims.

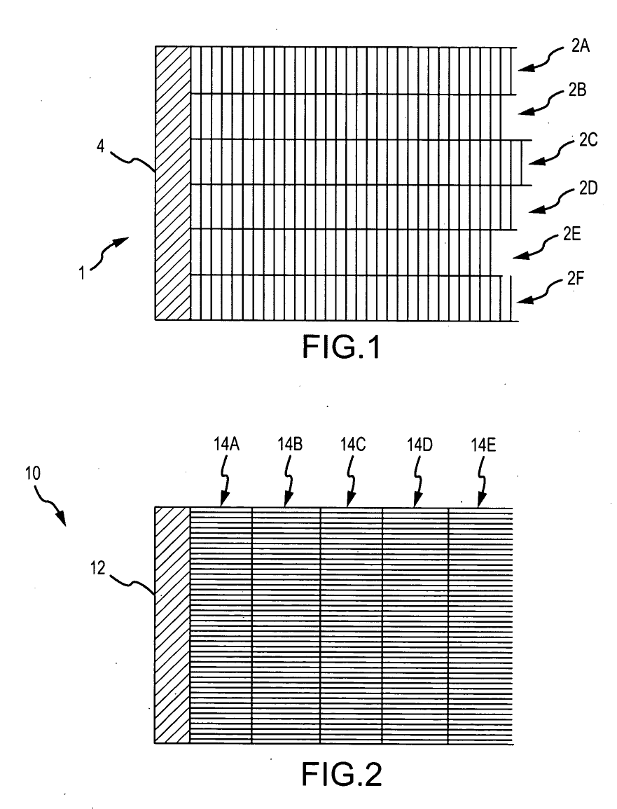

FIG. 2 illustrates one embodiment of a LC cell 10. The inventors have found that the method of alignment based on using an edge 12 that promotes the alignment of smectic layers 14A-E to be parallel to the edge 12, has significant advantages over the method of using an edge that promotes perpendicular alignment (i.e., the edge 2 of FIG. 1). The inventors have also found that there are issues in obtaining the full advantages of this method that were not expected, but the inventors have been able to overcome these issues in rather unexpected procedures.

The first issue that the inventors found was that it is very difficult to grow the desired layers 14A-E from an edge that included a formed solid surface. The inventors have found that a molecularly smooth or resilient surface is in fact preferred for this method to work well. The next issue that the inventors have found is that there is a significant tendency for the defects to form in the growing smectic domain. Under normal suggested methods or for any previously suggested cooling rate, these defects cause an imperfect alignment of the SmA layers 14A-E. However, the inventors found that if a very slow cooling rate of approximately 3 degrees Celsius per hour is used, in conjunction with a very high thermal gradient, that perfect, defect-free domains can be achieved.

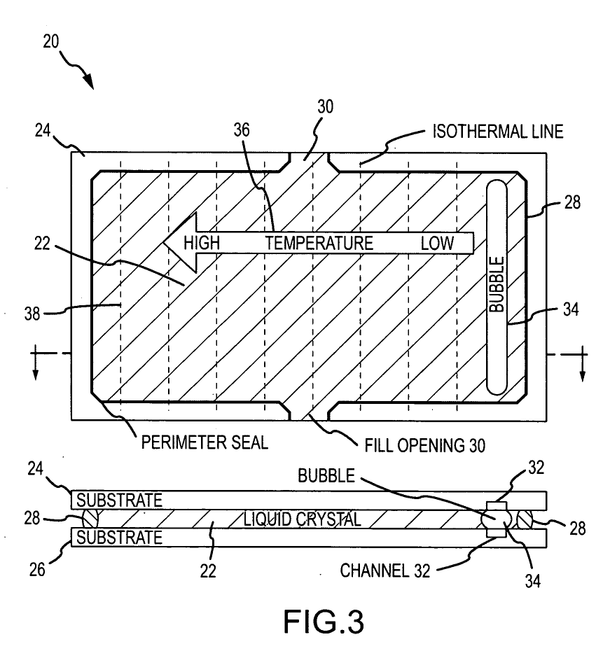

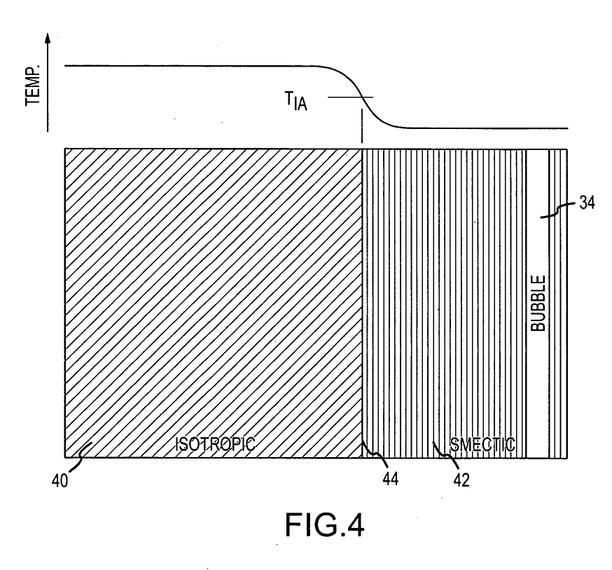

FIG. 3 illustrates top and cross-sectional views of a liquid crystal device 20 made according to the invention. A film 22 of liquid crystal material is confined between two plates 24 and 26, which may be attached to each other by a bead of adhesive 28 (the perimeter seal) to define an interior volume. Breaks in the adhesive bead 28 (i.e., the fill openings 30) provide a way to introduce liquid crystal 22 into the volume and for air to leave the volume as it is displaced by liquid crystal material 22.

Channels 32 are formed in the substrates 24 and 26 to define a region 34 where the gap between the substrates 24 and 26 is larger than elsewhere. This may be accomplished with matching channels 32 in both substrates, as shown here, or could be accomplished with a channel in only one of the substrates 24 and 26. The liquid crystal cell 20 so defined is filled with liquid crystal material 22 by capillary action. The cell 20 could be held at a temperature that brings the liquid crystal material 22 into its isotropic phase for this process. Capillary action will cause the LC material 22 to flow first into the thinnest places in the cell 20, that is everywhere in the cell but the channel 32. By carefully controlling the amount of liquid crystal material 22 provided (i.e. by not providing surplus material) the cell 20 can be filled with an air bubble 34 trapped over the channel 32. This air bubble 34 provides the edge for alignment of the LC material 22.

As another implementation, a vacuum void is used in place of the air bubble 34. In this case, it is clearer that the surface tension of the LC material itself is responsible for the molecularly smooth interface that is used as a nucleation boundary for the uniform smectic layers. The use of “nothing” or a void rather than a gas bubble has significant advantages in that the cell can be sealed under a low pressure so that the LC material can be thoroughly de-gassed and there will be issues with temperature variations in the completed device. A cell constructed with this implementation could have a similar design as shown in FIG. 3, but would be capillary filled under a vacuum to the point where the active area of the cell is filled, but the channel is not. This is not so difficult because the capillary forces are much larger for the thin region of the cell, and also the volume of the channel can be made to be similar to that of the entire thin region of the cell so that by control of the amount of material let into the cell, it can be impossible to fill the channel to a significant degree. After the cell is filled it can then be sealed under vacuum.

The channel in the substrate(s) can be formed photolithographically, by many methods well known in the art, for example by etching the substrate material. Since the edge of the bubble 34 will be used to provide the alignment direction for the subsequently grown smectic layers, it is usually desirable that the bubble edge be straight. To this end, it is further desirable that the channel 32 also be straight, with smooth edges.

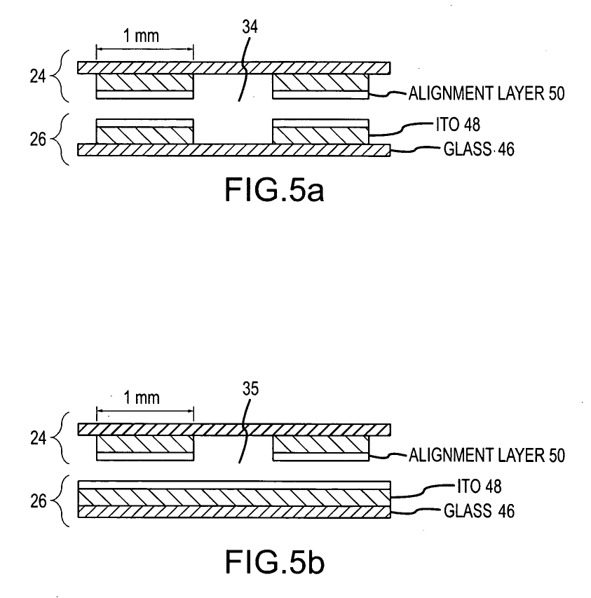

FIGS. 5A-B illustrate etched channels 34 and 35 in ITO 48 covered glass substrates 46 using a patterned photoresist layer and hydrofluoric acid. Upon completion of photolithography process, the substrates 46 were thoroughly washed and the alignment layer 50 was deposited. To demonstrate the effect, or lack of effect, of the surface alignment layer 50 on the smectic layer alignment using this method, the following surface alignment materials were used in different cells: ITO; SiOₓ deposited at 5° C.; SiOₓ deposited at 30° C.; Glymo (3-Glycidoxypropyl trimethoxysilan); Nissan 7511; and Dupont Polyimide 2555.

When assembling the cell 20, it is possible to use two substrates 24 and 26, each with channels (as shown in FIG. 5A), or just one substrate with channels and one plain ITO substrate (FIG. 5B). While it may be expected that the first case will yield a more symmetric air-LC interface, we found that in most cases the simpler second case also works well.

The cell gap was defined by powder spacers that were sprayed over substrates. The inventors measured the empty cell gap by interference method. For most of the alignment experiments, cell gap was approximately 4 μm, although some experiments were done for thinner cells (approximately 1.5 μm). The cells were filled with liquid crystal in isotropic state using the capillary filling method so that only the spaces between the channels were filled with liquid crystal, leaving the channels 34 and 35 to contain only air. The inventors used the following liquid crystals: 10CB, 12-S5, Displaytech MX 10498. All of these materials have the I-A-C phase sequence and gave similar results in the experiments. Other suitable LCs and mixtures could also be used.

After the channel 32 is formed and the substrates are assembled into a cell and filled with liquid crystal material in the isotropic phase, the cell can be cooled down to the temperature at which the liquid crystal is in its smectic phase. The cooling process should be arranged so that the region of the cell with the bubble 34 cools first (i.e., so that there is a temperature gradient perpendicular to the bubble 34), as shown by the arrow 36 in FIG. 3. The gradient should result in isothermal lines 38 parallel to the edge of the bubble 34.

FIG. 4 illustrates a graph of the temperature gradient at one point in time for the LC cell 20 of FIG. 3. The gradient could be uniform, with evenly spaced isothermal lines 38, as shown in FIG. 3, but this is not necessary. It is sufficient that the gradient exist in the vicinity of the phase front 44 between the isotropic 40 and smectic 42 phases, as shown in FIG. 4. The gradient should be such that the isothermal lines in the vicinity of the phase front 44 are parallel to the desired phase front position (which should be parallel to the bubble edge 34 at the time the phase front 44 emerges from the bubble 34).

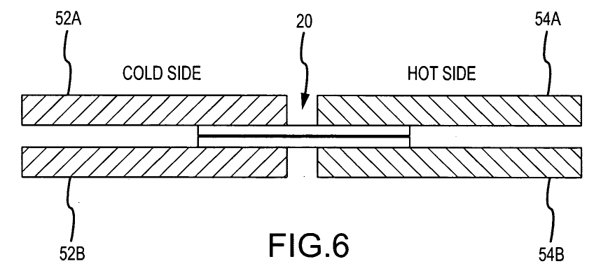

There are a variety of ways in which the desired gradients can be produced. For example, FIG. 6 illustrates one way where opposite ends of the liquid crystal cell 20 can be held by hot and cold blocks 54A-B and 52A-B, respectively. The liquid crystal cell 20 was placed in the middle between four metal plates 52A-B and 54A-B (two at each side), so that a thermal gradient was directed across the channels. In one embodiment, the distance between the plates was approximately 6 mm. The inventors used ceramic heating elements connected to a DC power supply to set the temperature of the hot plates 54A-B; while a refrigerated circulating water bath, for example Brookfield TC-602, was used to set the temperature of the cold plates 52A-B. Thermocouples with an electronic controller (for example, OMB-DAQ54 from Omega) were used to control the temperature of both sides of the heater. The inventors put this set up on the stage of a polarizing microscope to observe the alignment process.

After the cell 20 was put in the heater, the temperature of both sides was set so that the whole sample would become isotropic, and then started slowly cooling the cold side. The thermal gradient when the cold side was cooled sufficiently to cause the SmA-I transition line to be at the spatial location of an air-LC interface was approximately 10 K/mm (10 degrees Kelvin per mm). As the inventors continued to cool the cold side, the thermal gradient value gradually increased to about 20 K/mm when the SmA-I transition line had moved across the area of LC to be aligned.

Initially, the inventors observed a mono-domain, defect-free SmA stripe nucleate and grow from the air-LC interface. However, when the width of the uniform SmA stripe reached a particular width, they observed a dramatic structural change of the smectic phase. The typical value of this threshold width was approximately 20 μm. Before this change, smectic molecules were aligned normal to the nucleation edge.

After further cooling to allow the width of the SmA stripe to become wider, the inventors recognized that, along the cooler temperature side, the effect of the defects at the interface has weakened and a nearly uniform texture was seen. The result was not at first observed or expected, as will be discussed later. The inventors considered that once they observed the structural transition that high quality alignment of a larger area of the smectic phase would not be possible. However, they found that with extremely slow cooling rates, good alignment could be obtained.

In the beginning of cooling before the structural transition, when SmA stripe has not reached its critical thickness (i.e., approximately 20 μm), the cooling rate could be relatively high. Uniform smectic layers grew as a mono-domain as long as the cooling rate was lower than 1 K in 2 minutes. However, after the above-mentioned structure transition, the critical cooling speed was required to be slowed to around 1 K per 20 minutes, which approximately corresponds to a growth rate of the smectic stripe of 0.05 μm/s. For faster cooling rates, typically different types of defects appear, depending on the rate value.

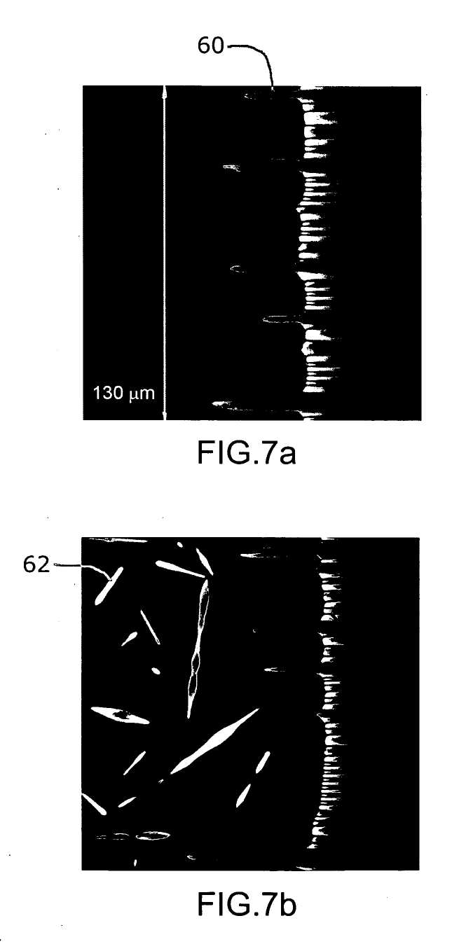

FIGS. 7A-B illustrate defects in the alignment process that were observed at higher cooling rates. If the cooling rate exceeded the very slow rate of about 0.05 μm/s, elongated batonettes 60 start to “shoot out” from the interface (FIG. 7a). If the cooling rate was increased further (to around 0.1 μm/s), batonettes 62 start to form the isotropic phase close to the interface (FIG. 7b). Such defects disrupt the mono-domain alignment. However, if they appear during the alignment process, it is possible to stop cooling and heat up the sample a little to the point where region with defects melted and then resume cooling.

If the cooling rate is kept low, the inventors have found it possible to obtain a fully aligned 1-mm-wide mono-domain sample. Although the set-up only allowed the 1-mm mono-domain size, it is clear that this method using an air interface for layer nucleation, a high thermal gradient, and a very slow cooling rate could be used to obtain arbitrarily large SmA domains.

In addition to using the hot and cold plates 54A-B and 52A-B shown in FIG. 6, a plurality of strip heaters could be provided on the cell substrates, either on the outsides, or preferably, on the insides. The heaters could be made of strips of some electrical conductive material, and operated by passing an electrical current through the strip. The strips could be arranged parallel to the channel and bubble edge. By passing more current through strips far from the bubble edge and less current through strips close to the bubble edge the desired temperature gradient can be obtained. Localized gradients like that shown in FIG. 4 could be obtained with such strip heaters by suitable control of the electrical currents passing through the various heaters. Furthermore, with such an arrangement it would be possible by suitably controlling the currents in the various strips to cause the position of the temperature gradient to move; for example to cause the phase front to emerge from the bubble and then progress across the cell aperture.

As an alternative implementation, the inventors propose a cooling station set-up that has peculiar characteristics of a steep temperature gradient near the isotropic side of the front, but a shallow gradient with the temperature just below the front transition temperature on the SmA side of the front. One implementation of this could be a station where the substrate is held at a temperature just below the front transition temperature; then at first a localized line heating is applied at and parallel to the nucleation interface and then scanned away from the interface. The localized line heating is provided by a laser beam that has a wavelength that is not absorbed heavily by glass, but is absorbed by a layer in close proximity to the LC layer (such as an ITO layer).

The first step in this method is to nucleate smectic layer growth with the smectic layers parallel to the nucleation interface and perpendicular to a temperature gradient. From our results, we conclude that to attain this goal a molecularly smooth interface is required, or one that can deform to become smooth as the SmA layers begin to grow. In our case the air-LC boundary layer provided this interface, but the results suggest that any smooth non-solid material that promotes parallel layer orientation would be satisfactory.

The main issue with obtaining uniform alignment with this method over a large area is related to the apparent focal conic defects that are seen at the SmA-I interface after they are nucleated. The inventors believe the nature of these focal conic defects is related to the structure of the air-SmA-I system. At the air-SmA interface, smectic layers prefer to align parallel to the interface (liquid crystal molecules are aligned homeotropically at the interface), while at the SmA-I interface the layers tend to align perpendicularly to it (planar anchoring of the director). This creates antagonistic boundary conditions for the liquid crystal in the cooling process, which are known to force texture distortions, involving both layer dilation and curvature, which, in turn, lead to the appearance of focal conic defects at the interface.

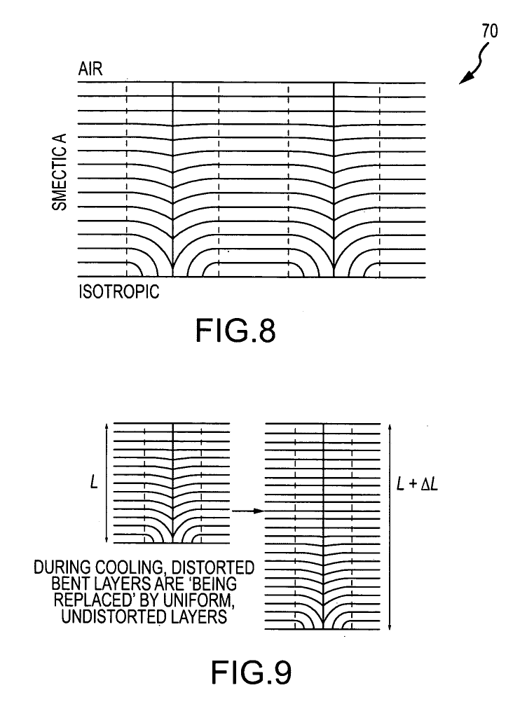

According to the model proposed in and our observations in the polarizing microscope, the inventors conclude that the layer structure of the SmA is similar to that shown in FIG. 8, which is a view from above the plane of the LC cell 70. However, the inventors have observed under the polarizing microscope that some regions never appear dark between crossed polarizers, regardless of the sample orientation with respect to the polarizers' axis. This implies some twisting of the layer structure through the thickness of the cell 20, and that the exact layer configuration may be more complex than shown in FIG. 8.

If the thickness of smectic slab in the cell is below some threshold value, a uniform layer structure is energetically preferable. The growth instability of a uniform smectic slab has previously been studied. It was experimentally found that a critical cooling rate for a system was about 25 μm/s. If the cooling rate exceeded this threshold, growth instabilities of the SmA-Iso interface led to nucleation of focal conic domains. It was proposed that this growth instability appeared very similar to this aforementioned instability, where growth velocity was limited by the diffusion of impurities. A calculated value of threshold cooling rate of about 50 μm/s was in a good agreement with the experimental results.

It migth be expected that once these focal conic defects nucleate that it will be not possible to continue the growth of a uniformly aligned SmA domain. And in fact, if we cool at the rate suggested in the previous paragraph, the inventors found that it is not possible.

However, the inventors' experiments have shown that if the cooling rate is decreased drastically, to approximately 0.05 μm/s, even after structural transition that causes focal conic defects at the SmA-I interface, uniform layer formation is possible. For this case, the inventors suggest that a threshold growth velocity is defined by the time that is needed for a structural transition from a distorted focal conic structure to a uniform undistorted one. The focal conics at the interface evidently are able to anneal with time and parallel smectic layers form in their place if the cooling rate is very slow. Therefore, the very slow cooling rate required for obtaining SmA mono-domain is related to the time of relaxation of distorted focal conic structure to the uniform layered structure, shown in FIG. 9.

The inventors have invented a method of spatial gradient cooling for alignment of SmA liquid crystals that have a SmA-I phase transition. We used an air bubble to create molecularly smooth edge for nucleation of smectic layers and to induce perpendicular molecular orientation for liquid crystal molecules. The inventors showed that in this case, while excellent smectic alignment is nucleated, antagonistic boundary conditions lead to nucleation of focal conic defects at the SmA-I interface. Most significantly, they have shown that even after these focal conic defects have formed, that uniform SmA regions can be grown by providing a high temperature gradient and very slow cooling rates (approximately 0.05 μm/s) that allow the focal conic regions to anneal to a uniform structure. They obtained very good quality of smectic layer alignment over large areas for different surface alignment layers. Further, they propose ways to increase the domain formation rate by changing shape and value of the temperature gradient, which will overall make our alignment method more convenient for industrial application.

While the invention has been illustrated and described in detail in the drawings and foregoing description, such illustration and description is to be considered as exemplary and not restrictive in character. For example, certain embodiments described hereinabove may be combinable with other described embodiments and/or arranged in other ways (e.g., process elements may be performed in other sequences). Accordingly, it should be understood that only the preferred embodiment and variants thereof have been shown and described and that all changes and modifications that come within the spirit of the invention are desired to be protected.

What is claimed:

1. A method of fabricating a liquid crystal display device, comprising:
providing a first substrate;
providing a second substrate;
spacing the first and second substrates apart by a gap;
providing a molecularly smooth edge within the gap;
providing a ferroelectric liquid crystal between the first and second substrates;
wherein a portion of the ferroelectric liquid crystal is in contact with the edge; and
aligning the ferroelectric liquid crystal by introducing a temperature gradient normal to the edge;
wherein the ferroelectric liquid crystal phase-changes into a smectic phase during the aligning step.

2. The method of claim 1, wherein the edge comprises an air bubble.

3. The method of claim 1, wherein the aligning includes cooling the ferroelectric liquid crystal at rate of below 3 degrees Celsius per hour.

4. The method of claim 1, wherein the temperature gradient is between approximately 10-20 K/mm.

5. The method of claim 1, wherein a plurality of smectic layers that are parallel to the edge are formed during the aligning step.
